(19) United States
(12) Patent Application Publication
(10) Pub. No.: US 2010/0121828 A1
(43) Pub. Date: May 13, 2010

(54) RESOURCE CONSTRAINT AWARE NETWORK FILE SYSTEM

(76) Inventor: You Wang, Longmont, CO (US)

Correspondence Address: SCHWEGMAN, LUNDBERG & WOESSNER, P.A., P.O. BOX 2938, MINNEAPOLIS, MN, 55402, US

(21) Appl. No.: 12/616,672

(22) Filed: Nov. 11, 2009

Related U.S. Application Data
(60) Provisional application No. 61/113,345, filed on Nov. 11, 2008.

(51) Int. Cl. G06F 17/00

(52) U.S. Cl. 707/694; 707/E17.007

(57) ABSTRACT

A system and method for presenting a uniform file system interface for accessing multiple storage devices where at least one of the storage devices has some resource constraints. The system includes an intermediary device abstracting the individual storage devices and aggregating the storage available on each device into a single volume while accounting for each individual storage device's resource constraints.

### RELATED APPLICATIONS

This application claims the benefit under 35 U.S.C. 119(e) of U.S. Provisional Patent Application Ser. No. 61/113,345, filed on Nov. 11, 2008, which is incorporated herein by reference in its entirety.

### TECHNICAL FIELD

The present invention is related to computer data storage systems, and more particularly, to a system and method for presenting a multi-device, multi-tier storage system to a client device as a single unified file system.

### BACKGROUND

As the amount of electronic data retained by organizations continues to skyrocket, interest in scalable and inexpensive data storage solutions continues to grow. Traditionally, data storage has consisted of disk-based devices (direct-attached hard drives and network-attached storage devices), removable magnetic media (disk and tapes), optical disks, and more recently flash memory devices. These various storage technologies all have different costs which generally follows the trend of higher cost equating to higher performance from a data availability and access time perspective. For example, hard disk drive arrays are more expensive (per megabyte stored) than a slower access time technology such as an optical disk jukebox.

The cost/performance trade-off represented by the various storage technologies has led to the development of hierarchical storage management (HSM). HSM is a data storage technique that utilizes various “tiers” of storage device for storing data with varying retrieval requirements. Data requiring frequent or immediate access is stored on high-speed, high cost devices, while data requiring less frequent or less immediate access can be migrated onto lower cost, slower storage media.

Storage tiers are often discussed in terms of primary, secondary, tertiary and off-line storage mechanisms. Primary storage is typically viewed as that storage which is directly accessible by the central processing unit (CPU). Primary storage is commonly referred to simply as memory. Secondary storage is storage that is directly attached to the computer (e.g. hard drive drives). When the concept of data storage is discussed, secondary storage is thought of as the primary mechanism. Tertiary storage devices include everything from network-attached disk-based devices to optical jukeboxes. Offline storage is considered tapes, disks or other media which can retain data, but are not accessible until loaded into a read/write mechanism.

While vendors provide various storage offerings which attempt to utilize the HSM concept, no one has developed a solution that seamlessly integrates storage devices from multiple vendors that span multiple tiers of performance.

### BRIEF DESCRIPTION OF THE DRAWINGS

FIG. 1 illustrates an example embodiment of a system for presenting a multi-device, multi-tier storage system to a client device as a single unified file system.

FIG. 2 illustrates another example embodiment of a system for presenting a multi-device, multi-tier storage system to a client device as a single unified storage volume.

FIG. 3 illustrates the migration of data between different storage tiers within a resource constraint aware network file system.

FIG. 4 illustrates an example embodiment of a resource constraint aware network file system including the metadata structure, device group configuration and content segment usage.

FIG. 5 illustrates an example embodiment of the metadata and content segment data structures.

FIG. 6 illustrates an example method for writing data to a resource constraint aware network file system.

FIG. 7 illustrates an example method for reading data from a resource constraint aware network file system.

FIG. 8 illustrates an example method for determining which data files should be migrated within a multi-device, multi-tier storage system.

FIG. 9 illustrates an example method for migrating data files within a multi-device, multi-tier storage system.

FIG. 10 illustrates an example method for provisioning new storage devices into a multi-device, multi-tier storage system.

FIG. 11 is a block diagram of a machine in the example form of a computer system within which instructions for causing the machine to perform any one or more of the methodologies discussed herein may be executed.

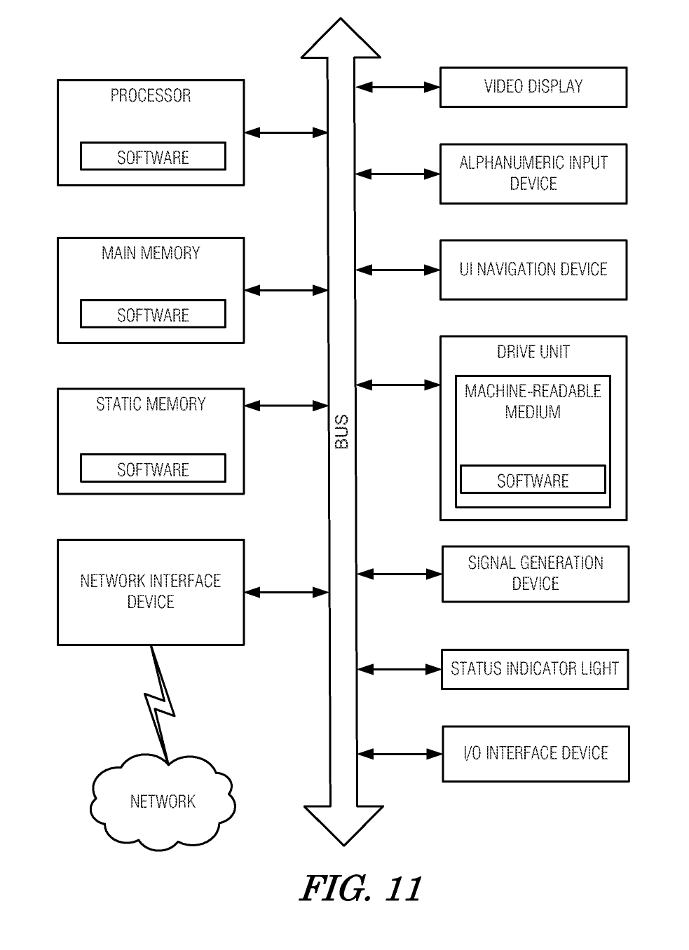

FIG. 12 illustrates an example embodiment of a system for presenting a multi-device, multi-tier storage system to a client device as a single unified storage volume.

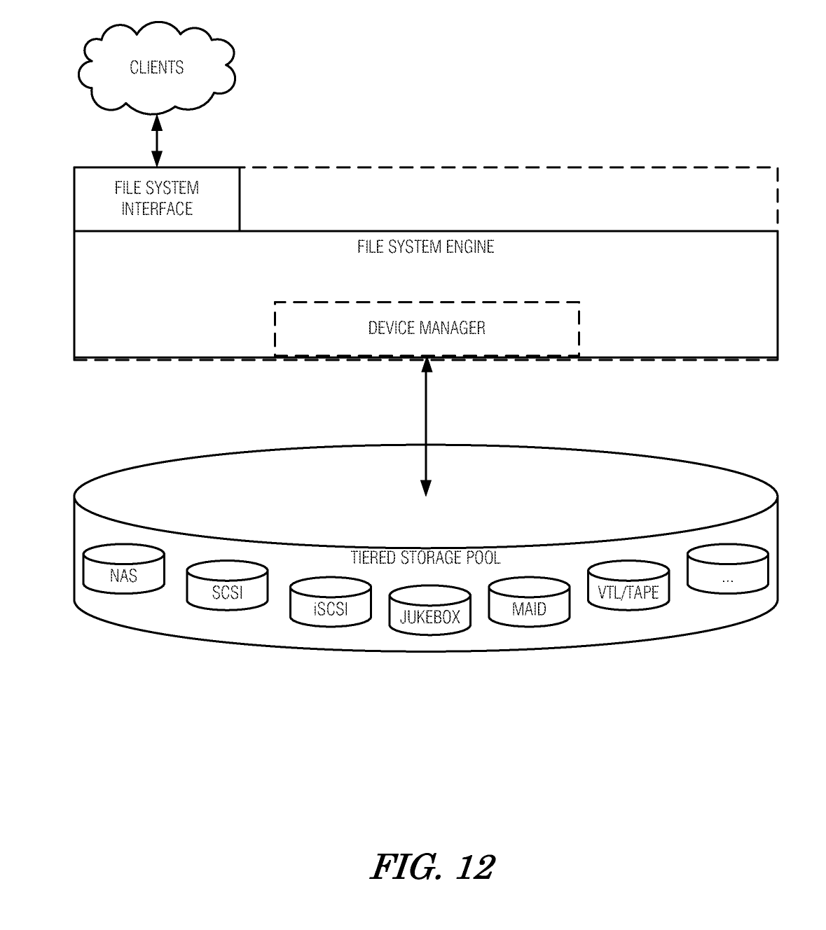

### SUMMARY

The above mentioned problems are solved by presenting a single unified file system interface to a multi-device, multi-tier storage system that seamlessly handles resource constrained storage devices. In addition to the above mentioned problems, other problems are addressed by the present invention and will be understood by reading and studying the following specification.

According to one aspect of the invention, a data management system presents to a client device a uniform file system interface for accessing multiple data storage devices. In one embodiment, the data management system includes a server connected to the multiple data storage devices. In an exemplary embodiment, the server has a file system engine component capable of connecting to the client device and the multiple data storage devices. The file system engine is capable of maintaining resource constraint information regarding the multiple data storage devices. Additionally, in another embodiment, the file system engine is capable of presenting the multiple data storage devices to the client device as a single data storage volume. In this embodiment, the file system engine accesses a storage policy and distributes portions of the data file across the plurality of storage devices as a function of the storage policy. The file system engine can also distribute portions of the data file as a function of the resource constraint information associated with each data storage device.

Another aspect of the invention comprises a system for storing data that includes a first data storage device, a second data storage device, and a server. The first data storage device is formatted according to a first file system format and the second data storage device is formatted according to a second file system format. In one embodiment, the second file system format is different than the first file system format. In another embodiment, the second storage device is resource constrained. Example resource constrained storage devices include a massive array of independent disks or an optical jukebox. In this aspect of the invention, the server is connected to the first and second data storage devices. The server also includes a file system interface and a file system engine that is connected to the file system interface. The file system engine is also connected to the first and second data storage devices. In an example embodiment, the file system interface provides one or more file system methodologies (also referred to as file system formats) for accessing the first and second data storage devices. One embodiment, also includes the file system interface providing access to the first and second data storage devices as a single unified storage volume.

Yet another aspect of the invention provides a method of writing data to a storage system. In one embodiment, the write method operates within a storage system that provides a file system interface to multiple storage devices. In this embodiment, the file system interface responds to write requests in one or more file system formats. In another embodiment, one of the one or more file system formats differs from the file system formats used by the multiple storage devices.

In an exemplary embodiment, the write method includes receiving a request to write data onto the storage system at the file system interface. After receiving the write request, the method determines a target storage device and a content segment on the target storage device. Determining a target storage device and content segment includes determining whether the request is directed toward an existing data file. If the current request is directed to an existing data file then a meta data file associated with the existing data file is opened. After the existing data file is opened, the method determines whether the current request is to an existing content segment (portion) of the existing data file. If the request is to write to an existing content segment, then the target storage device associated with the existing content segment is obtained from the metadata file. However, if the current write request is to an new content segment, then an available storage device is selected as the target device and a new data entry associated with the content segment is created within the metadata file.

In this embodiment, if the current write request is directed to a new data file, then a new metadata file associated with the new data file is created. After creating the metadata file an available storage device is selected as the target device. Once the target device is selected a data entry associated with a new content segment is added to the new metadata file.

After determining a target storage device and content segment, this embodiment continues by connecting to the selected target storage device and opening the content segment within the selected target storage device. Then at least a portion of the data associated with the write request is written to the content segment. Finally, the metadata file associated with the content segment to which the data was written is updated.

Still another aspect of the invention provides a method of reading data from a storage system. In one embodiment, the read method operates within a storage system that provides a file system interface to multiple storage devices. In this embodiment, the file system interface responds to read requests in one or more file system formats. In another embodiment, at least one of the file system formats differs from the multiple file system formats used by the multiple storage devices.

The read method starts by receiving a request to read data from the storage system at the file system interface. In this embodiment, the read method then reads one or more metadata files associated with the read request and locates one or more content segments listed in the metadata file associated with the read request. The read method continues by accessing at least one storage device containing one or more of the content segments. Finally, the read method retrieves the one or more content segments and returns the requested data.

### DETAILED DESCRIPTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

The systems and methods of the various embodiments described herein allow a client device to connect seamlessly to multiple storage devices as if they were a single large storage device. The multiple storage devices may include devices which are resource constrained. A resource constrained device is any device which may not be able to immediately service an input or output request due to either physical or electronic constraints. Examples of resource constrained storage devices include devices such as tape libraries or optical jukeboxes. Storage devices with varying levels of resource constraint are often logically grouped into “tiers” of storage. As discussed above, storage can be discussed in terms of primary, secondary, tertiary, and offline. However, it is also common to refer to storage tiers as including online, near-line, and offline type devices, but there can be any number of levels within each of these broad categories.

Traditional file systems assume that all data contained within a storage volume is online and accessible preventing effective use of resource constrained storage devices. This limitation of traditional file systems forces the use of either more expensive storage media or the integration of proprietary storage solutions. Therefore, a solution that allows for the use of various tiers of storage from various vendors presented as a single unified storage volume provides a flexible and cost-efficient data storage system, which can be easily tailored to meet a variety of data storage scenarios.

The systems and methods of the various embodiments described herein provide solutions by implementing a resource constraint aware network file system capable of presenting multiple storage devices operating within multiple tiers as a single unified storage volume.

### System Architecture:

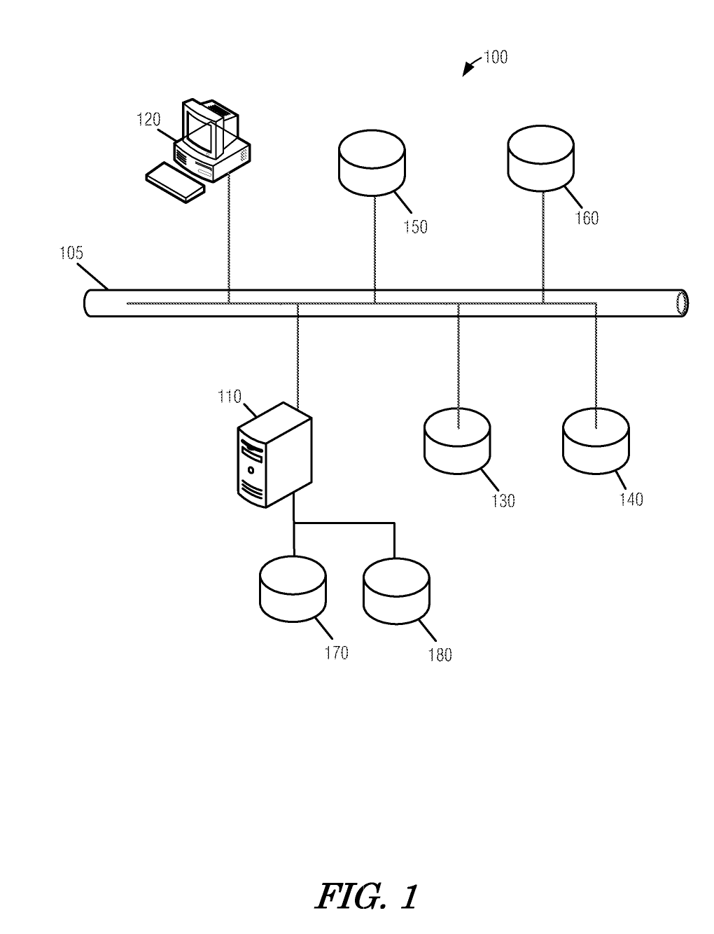

FIG. 1 illustrates a data storage system 100 which depicts an exemplary embodiment of the resource constraint aware network data storage system. Data storage system 100 includes a network 105, a plurality of storage devices 150-180, a file server 110, and a client device 120. For the purposes of illustration in the various embodiments the file server 110 provides the client device 120 access via an industry standard file system interface, such as CIFS/SMB or NFS, to one or more of the storage devices 130-180. This example embodiment depicts the various storage devices as either directly attached to the file server (170 and 180) or attached via a network connection 105. It is understood by one of skill in the art that the file server 110 can connect to a storage device via any known method including, SCSI, iSCSI, network-attached (NAS), Fibre Channel, or a web storage interface.

In an example embodiment, the file server 110 utilizes a UNIX file system that is POSIX file system compliant and operates on a Unix/Linux operating system. However, another example embodiment can utilize a file server 110 running a Windows™ based operating system and associated file system.

The client device 120 connects to the file server 110 over network 105 to read or write data to any of the connected storage devices 130-180. The client device accesses a single unified storage volume that represents the aggregated storage space available on the various storage devices. The file server 110 manages the various connections and any translation between the client device's file system and the file systems running on the various storage devices, which may or may not be compatible. As will be described in more detail below, the file server 110 maintains a representation of all data stored on the various storage devices (130-180) by the client device 120. Additionally, the file server 110 transparently manages the storage location of client data to ensure maximum performance. The file server 110 retains performance characteristics for each of the storage devices and file access requirements for each file (or even portion of a file) stored by the client device 120 to facilitate performance management.

The following sections provide additional detail regarding the file server's 110 internal operations, hierarchical data management techniques and storage device (130-180) management.

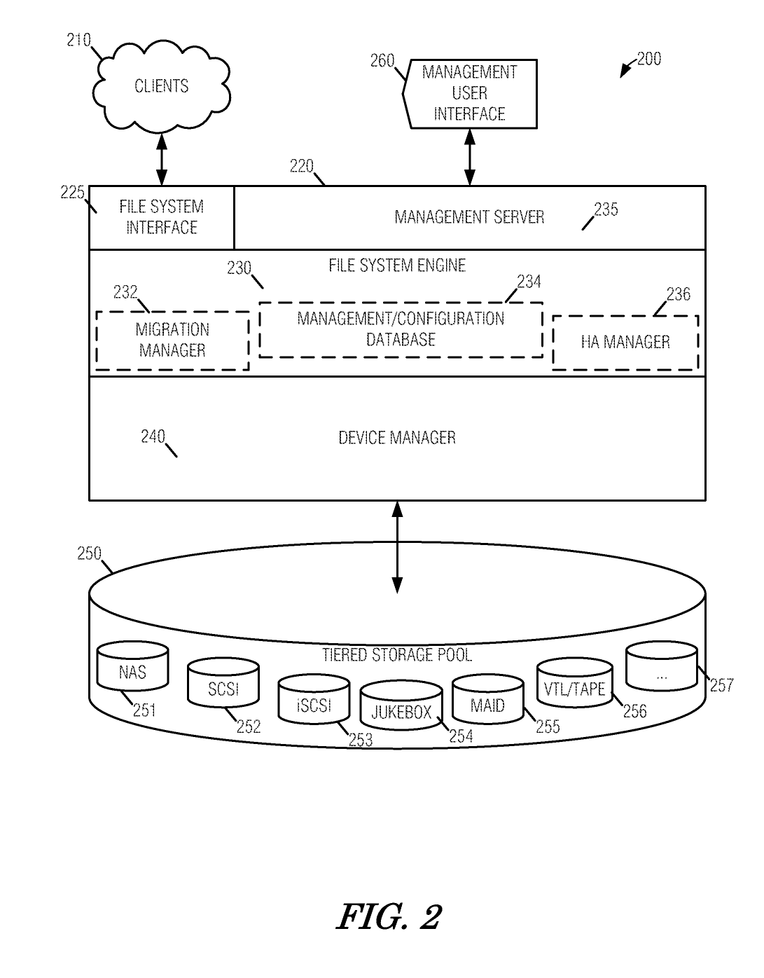

FIG. 2 illustrates another example embodiment of a system for presenting a multi-device, multi-tier storage system to a client device as a single unified storage volume. FIG. 2 illustrates a more detailed view of the file server 110, 220 operating components including, the file system interface 225, management server 235, file system engine 230, and device manager 240. FIG. 2 also depicts the major components of the data storage system outside of the file server 220 including, client devices 210 and the tiered storage pool 250 that includes a variety of storage devices 251-257.

In this embodiment, the file system interface 225 is the primary functional connection through which a client device 210 reads or writes data to the storage system 200. In an exemplary embodiment, the file system interface 225 will operate a NFS or CIFS server in order to present an industry standard file system interface to the client device 210. Internally, the file system interface 225 primarily interacts with the file system engine 230, which handles most of the data storage tasks performed by the system 200.

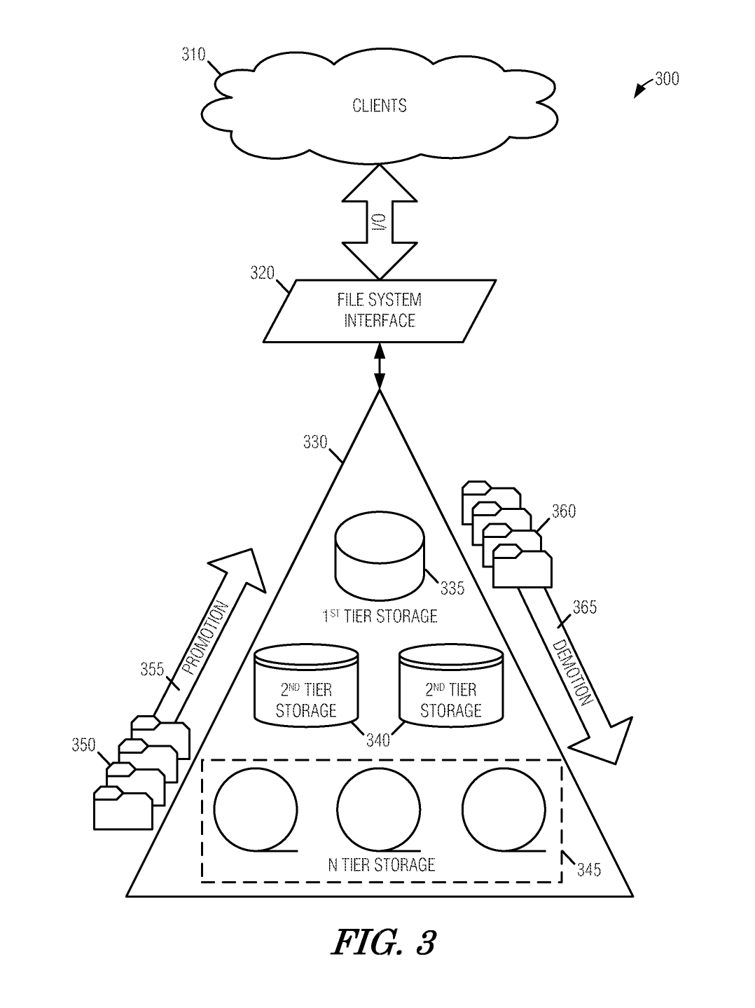

In this embodiment, the file system engine 230 represents the heart of the resource constraint aware network file system. The file system engine 230 handles representing the various individual storage devices 251-257 as a single unified file system, which the file system interface 225 then makes accessible to the client device 210. The file system engine 230 also controls all input and output (I/O) to the system 200 and manages data placement and movement among the storage tiers within the tiered storage pool 250. The migration manager 232, handles the task of moving the files among different storage tiers based on storage polices. In an example embodiment, storage polices include file attributes such as creation date, last access time, file type, access frequency, file size, and department among other things. The discussion of FIG. 3 below provides additional details on exemplary embodiments and functionality of the migration manager 232.

In an example embodiment, the High-availability (HA) Manager 236 coordinates multiple resource constraint aware file systems to be run simultaneously to ensure access to the tiered storage pool 250 in the event of a failure in one instance.

Management and configuration database 234 stores all configuration and management data for system operations. For example, device group information is stored in the database along with administrative information including user accounts, alert setups, and administrator contact information.

In an embodiment, the file system engine 230 connects to the storage devices 251-257 over existing file system protocols such as EXT3, GFS/GFS2, XFS, JFS, ORFS/ORFS2, or other Unix/Linux file system formats. In an exemplary embodiment, the file system engine 230 utilizes file level access except with storage devices such as tape or optical devices or any device that only presents a block level interface, where block level interfaces are employed.

The device manager 240 interacts with the file system engine 230 and the tiered storage pool 250 to obtain individual devices 251-257 for I/O operations by the file system engine 230. The device manager 240 prepares and mounts the individual storage devices 251-257 when needed for an operation by the file system engine 230. In an example embodiment, preparing a storage device 251-257 includes powering on the device, moving media into a read or write position, or spinning up a disk. For example, in a MAID (massive array of idle disks) device typically fewer than twenty five percent of the drives will be spinning at any give time. If a MAID system 255 were one of the connected storage devices 251-257, the device manager 240 determines whether the requested data is on an already spinning disk. If the target disk(s) is not already spinning, the device manage 240 spins up the target disk(s) prior to mounting the device for I/O operations with the file system engine 230.

TABLE 1
Device Manager Functions

Get_Device_by_Size
Get_Device_by_Size_Tier
Get_Device_by_Id
Get_Working_Device
Release_Device

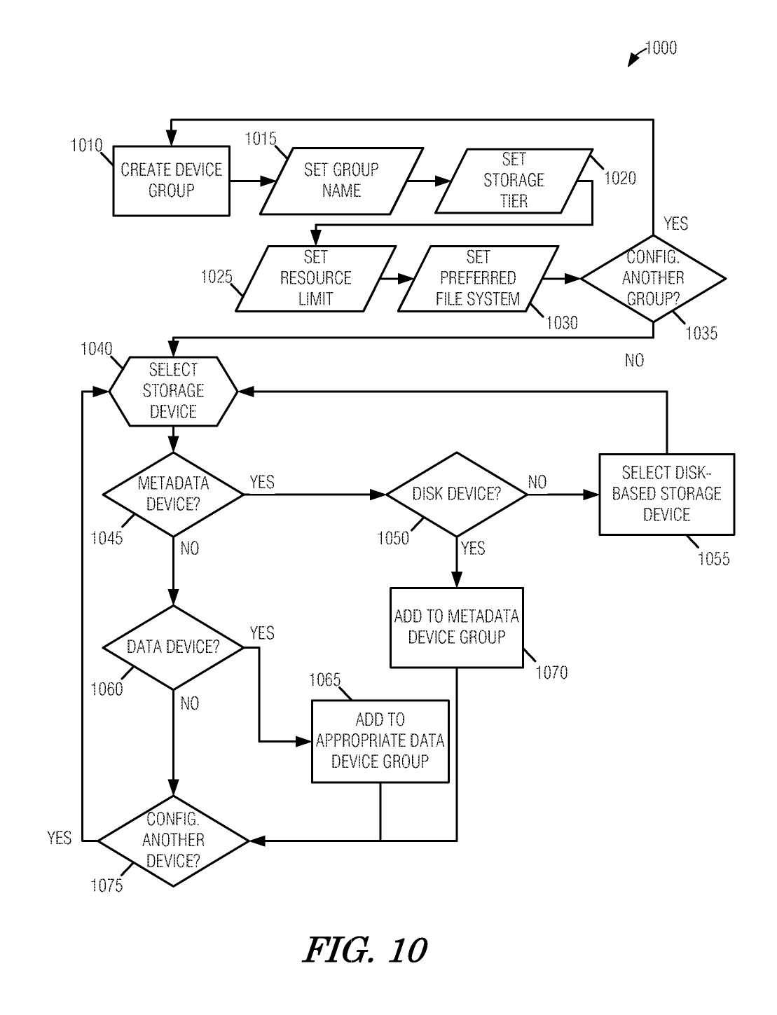

In an exemplary embodiment, the device manager 240 is programmed to perform the functions listed in table 1. The Get_Device_by_Size function selects and returns a device from the tiered storage pool 250 with available storage space exceeding the minimum size requested. The Get_Device_by_Size_Tier function selects and returns a device from the tiered storage pool 250 in a specified storage tier and with available storage space exceeding the minimum size requested. In an embodiment, storage tier may be indicated by specifying a device group (explained in more detail below) or by specifying a resource limit. In an exemplary embodiment, the resource limit is used to indicate the maximum number of concurrently accessible devices or I/O points within either a device group or a physical storage device. The Get_Device_by_Id function finds and returns the specified device by a unique identifier created for each storage device during the provisioning process 1000 (see FIG. 10). In an exemplary embodiment, the device identification is a universally unique identifier (UUID) created utilizing a hashing function. A UUID is a 128 bit number created utilizing a standard promulgated by the Open Software Foundation (OSF). The OSF supports five versions of UUID creation including MAC address, DCE security, MD5 hash, random numbers and SHA-1 hash. In another embodiment, any of the techniques included in the OSF standard can be used in generating a UUID for a storage device. The Get_Working_Device function selects and returns a device from the tiered storage pool 250 to be used for new data writes. In an example embodiment, the Get_Working_Device function utilizes a best device first algorithm to select the working device returned. In this embodiment, the best device first algorithm selects a storage device (251-257) based on device performance characteristics and device group properties. The algorithm balances factors such as storage tier, device performance and device group budget. In an exemplary embodiment, the “best” device is determined by finding the available storage device in the lowest tier (highest performing tier) whose device group has the highest available budget. The Release_Device function returns the device back to the tiered storage pool 250. The Release_Device function will also unmount the device if necessary.

The management server 235 interacts with the management user interface 260 and the file system engine 230. In another embodiment, the management server 235 interacts with the management user interface 260, the file system engine 230 and the file system interface 225. The management server 235 provides for user authentication and account management. The management server 235 includes a device scanning function for discovering new storage devices and detecting offline devices. In an embodiment, the management server 235 interacts with the file system interface 225 providing management functions. In an example embodiment, the management server 235 manages NFS export and CIFS shares, acting as a NFS/CIFS share manager. The management server 235 provides event management services for the file server 220. In an example embodiment, event management includes processing system events and generating alerts accordingly. The management server 235 also maintains system logs and interacts with industry standard network management systems.

In one embodiment, the management server 235 in conjunction with the management user interface 260 provide a command-line interface (CLI) and graphical user interface (GUI) for configuration and management of the data storage system 200.

### Storage Data Structure:

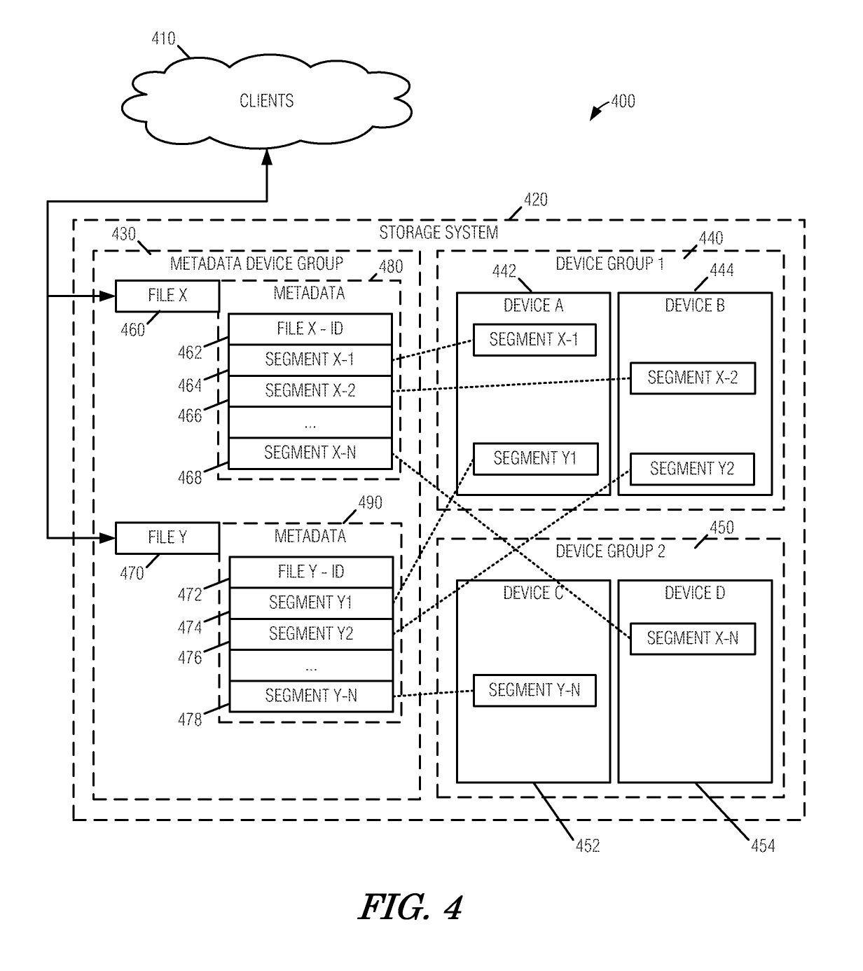

FIG. 4 depicts an illustration of the data structure employed by an exemplary embodiment of the resource constraint aware network file system. The storage data structure 400 revolves around concepts including metadata 480, 490, device groups 430, 440, 450 and the stored content represented by content segments 462-468, 472-478. The storage system 420 breaks up any file 460, 470 stored by a client device 410 into one or more content segments 462-68, 472-478, which are subsequently stored on the various storage devices 442, 444, 452, 454 within the various device groups 440, 450. The abstraction from the actual file content 464-468 and 474-478, provided by the metadata 480, 490 allows the system 420 to efficiently distribute content across multiple storage devices 442, 444, 452, 454 and better manage any resource constraints. Separating the metadata entries 480, 490 from the content segments 462-468, 472-478 allows the system to freely migrate the content between different tiers of storage, represented within the system 420 by the device groups 440, 450, while always maintaining a proper directory structure for the client devices 410.

By way of example, if File X 460 were a large video file the first few content segments 464, 466 are stored in a tier one or secondary (e.g. high performing and always available) device group 440; while later portions 468 of the file are stored in lower tier or tertiary device groups 450. In one example, when the client device 410 attempts to read File X 460 early portions of the file 464, 466 can be streamed over immediately off of the tier one storage devices 442, 444, while the system retrieves the later segments 468 off of the more resource constrained devices 452, 454 in lower tier device group 450.

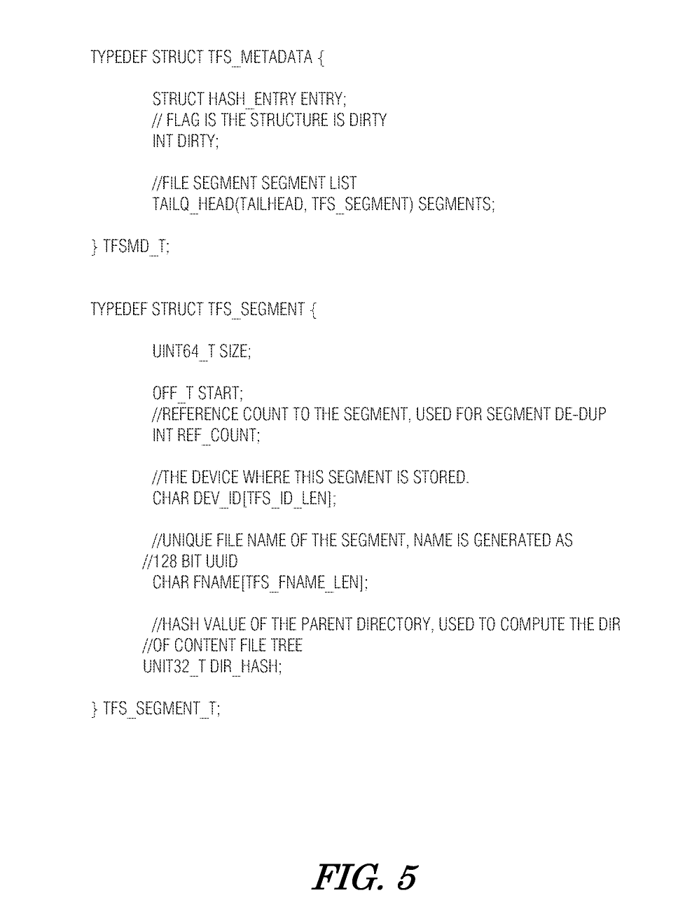

In an exemplary embodiment, metadata 480, 490 is utilized to represent to client device 410 files 460, 470 and maintain the locations of the actual content segments. FIG. 5 depicts an example embodiment of computer instructions implementing the metadata structure. As shown in FIG. 4, the metadata 480 structure includes a file ID 462 and a list of one or more content segments 464-468. Metadata entries 480, 490 are stored in a directory structure which reflects the structure created by the client devices 410 while storing data files 460, 470.

In an exemplary embodiment, the metadata entries 480, 490 are stored on storage devices within the metadata device group 430. In order for a device to be included in the metadata device group 430 it must be a tier one device. In an example embodiment, the storage devices within the metadata device group 430 are all disk drive type devices, such as directly attached SCSI drives. In another embodiment, the metadata device group 430 can be populated with a directly attached RAID (redundant array of individual disks) device, providing high performance and some level of disaster protection. In yet another embodiment, the metadata device group can be populated with a network-attached disk-based device. The metadata device group 430 must be populated with high performance storage devices in order to ensure that the directory structure represented by the metadata entries is always available to client devices 410.

In one embodiment, device group 1 440 and device group 2 450 represent different tiers of storage devices connected to the storage system 420. Each device group 440, 450 contains storage devices 442, 444, 452, 454 which have similar resource constraint characteristics. In an example embodiment, device group 1 may hold all the storage devices 442, 444 which have no resource constraints. An example non-resource constrained storage device is a direct-attached or network-attached RAID device. In this embodiment, device group 2 450 may hold storage devices 452, 454 which are resource constrained. An example resource constrained storage device is an optical jukebox. An optical jukebox is constrained by the limited number of I/O devices and the latency associated with loading the correct piece of media into the I/O device. In an exemplary embodiment, the storage system 420 utilizes the concept of “a budget” to represent a storage device's resource constraint. Storage devices with the same resource budget are put into the same device group 440, 450. During operation, the storage system 420 keeps track of a storage device's budget utilization to determine whether the device is free to handle additional I/O operations. In another embodiment, the storage system 420 tracks the device group's budget utilization to determine which group can held additional I/O operations.

### Methods of Use:

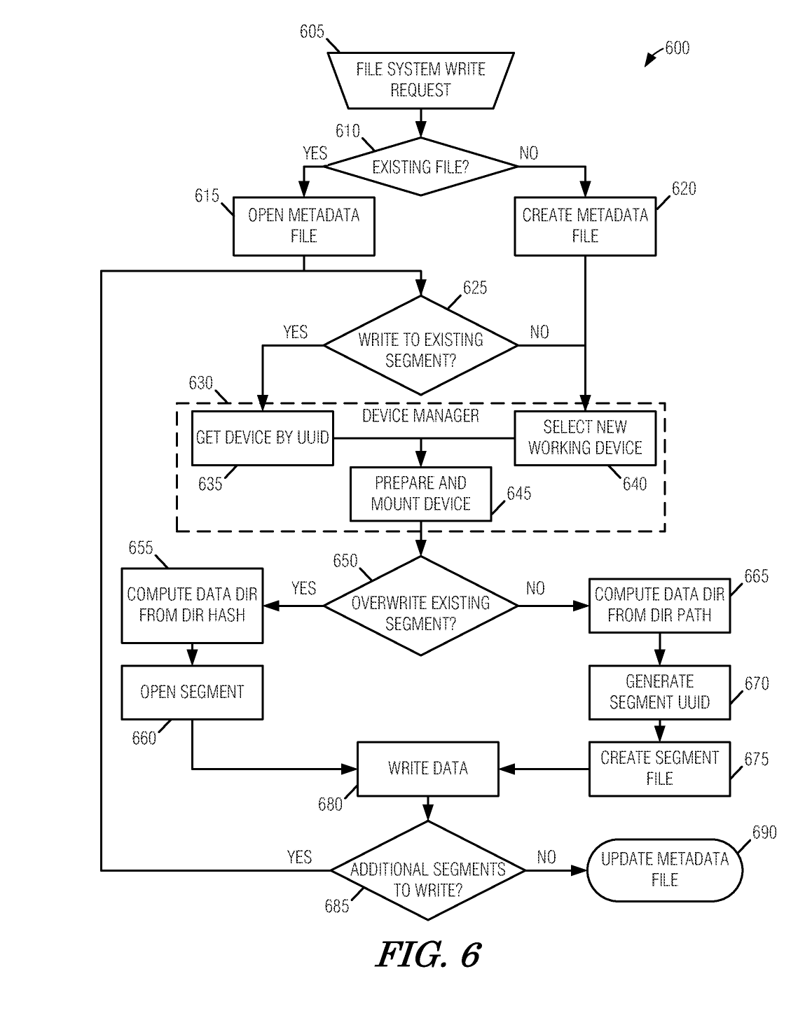

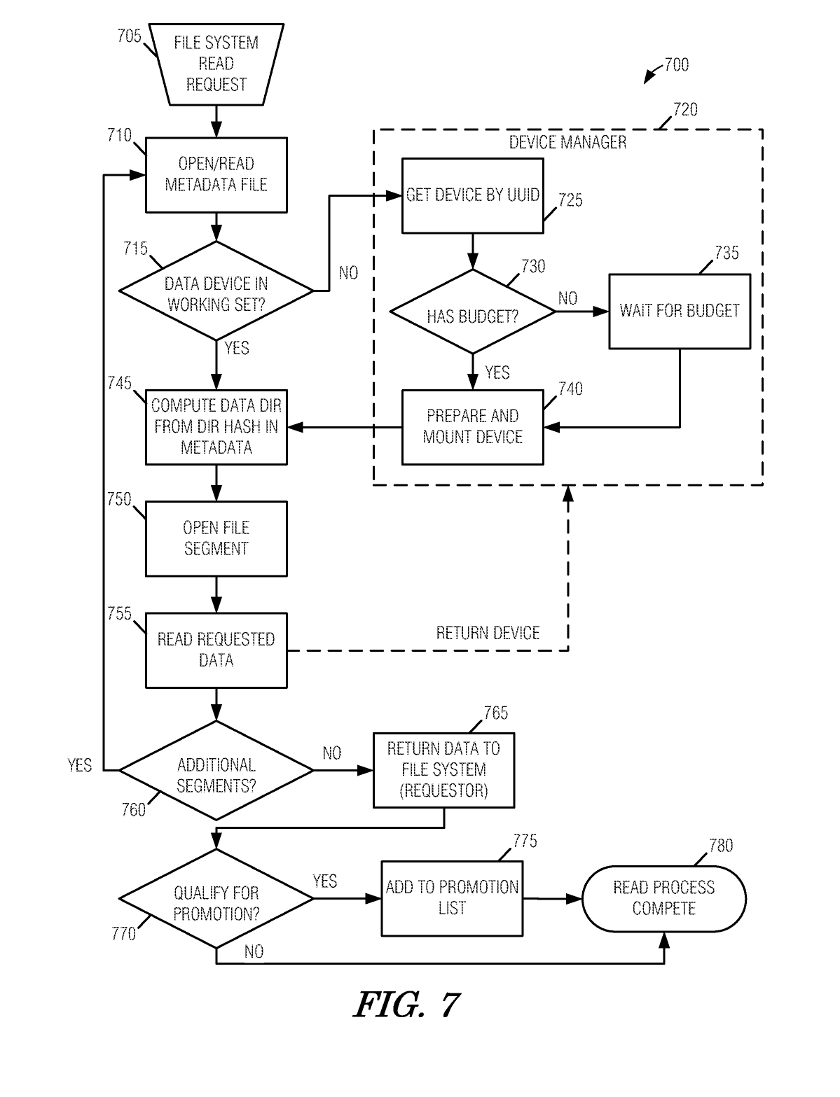

The following description of methods of utilizing a resource constraint aware network file system focuses on FIGS. 6 and 7. However, for improved clarity references will be made back to system level components depicted in FIGS. 2 and 4.

FIG. 6 illustrates an exemplary method 600 of writing data into a resource constraint aware network file system. The method 600 begins by receiving a file system write request 605. The write request 605 is received by the system 220 at the file system interface 225 and transferred to the file system engine 230 for processing.

Next, the file system engine 230 determines whether the write request is directed towards an existing file 610 (a file previously stored by a client device 210). If the file does exist, the file system engine 230 will open the associated metadata entry (file) 615. If the file does not already exist within the storage system, the file system engine 230 will create a new metadata entry 620.

After determining whether the file being written exists at 610, the method 600 selects a working device 625-640. In one embodiment, the working device is the storage device the method 600 will utilize to service the write request. If the write request is directed at an existing file, the method 600 determines whether to write to an existing content segment 625. If the write request is directed to an existing content segment, then the working device is determined by obtaining a device ID from the content segment 635. Obtaining a working device (e.g. 635 or 640) is done within the device manager 630.

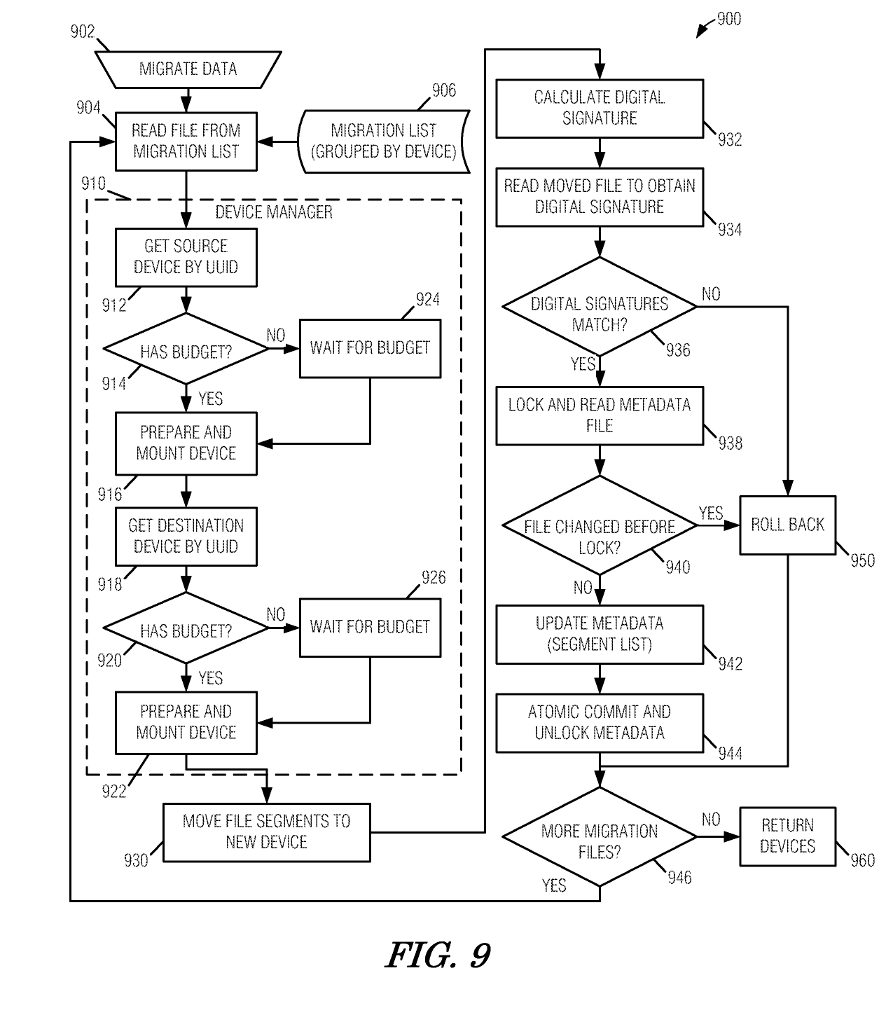

If the write is directed to either a new file or a new content segment, then a new working device must be selected at 640. In an exemplary embodiment, selection of a new working device occurs based on a best device first algorithm. The best device first algorithm utilizes the device manager 230 to scan the storage devices for the best available device. In another embodiment, the best device first algorithm utilizes the device manager 230 to scan the storage groups for the group with the largest budget available. In an exemplary embodiment, the “best” device is determined by finding the available device in the lowest tier (highest performing tier) whose device group has available budget. In an exemplary embodiment, the system (e.g. 420) migrates data to ensure that write requests can always be effectively serviced. The data migration process is described in more detail in reference to FIG. 9 below.

Once the working device is selected the device manager 630 will prepare and mount 645 the device. Preparation of the storage device includes operations such as powering on the device, moving the media into an I/O position, or simply spinning up the disk. Mounting the device involves making it accessible to the file system engine 230 for I/O operations.

The next step is to determine if the write request 605 will overwrite an existing content segment 650. If the requested write 605 overwrites an existing content segment, the file system engine 225 accesses the directory hash, contained in the content segment data structure, to compute the data directory 655. Then the content segment will be opened 660 and the data written 680.

If the write request will not overwrite an existing content segment, then a data directory will be computed from the directory path 665 by the file system engine 230. A unique identifier will be generated for future identification of the content segment at 670. In one example embodiment, the content segment identifier is a UUID created with one of the methods outlined above. Next, the method 600 creates the content segment 675 and writes the data 680.

After writing data to a content segment, the method 600 checks to see if the write request requires additional content segments to be written 685. If there are additional content segments to be written, the method 600 loops back to determining whether the request is directed at another existing segment at 625.

The write method 600 is completed by updating the metadata file 690 that represents the written data back to a client device (e.g. 410).

FIG. 7 illustrates an exemplary method 700 of reading data from a resource constraint aware network file system. The method 700 begins by receiving a file system read request 705. In an exemplary embodiment, the file system interface 225 receives the read request 705 and transfers the request 705 to the file system engine 230 for processing.

The read method 700 proceeds by opening and reading the metadata file 710. At 715, the method 700 determines whether the required working device is in the working set. In one embodiment, the file system engine 230 determines whether the required working device is in the working set at 715. In an example embodiment, the working set is a plurality of storage devices currently mounted for I/O operations. If the device is in the working set the method 700 proceeds at 745. However, if the storage device is not in the current working set, then the device manager 720 gets the device by ID starting at 725. In an exemplary embodiment, each storage device is given a UUID when it is added to the storage pool (e.g. 250). The device provisioning process is explained in greater detail below in reference to FIG. 10.

In one embodiment, when getting a device by ID 725, the device manager 720 must determine if the device has budget 730. If the device does not have budget, then the method 700 will have to wait for budget 735 before servicing the read request. If the device has budget, the device manager will prepare and mount the device 740 to service the read request. At this point, the device becomes part of the system's working set.

In another embodiment, getting a device by ID 725 includes determining if the device group has budget at 730. A device group's budget reflects the either logical or physical resource constraints of the storage devices included in the device group. If the device group does not have budget, then method 700 waits for budget to become available at 735. If the device group has budget, the method 700 prepares and mounts the device at 740.

Once the required device is in the working set, the file system engine 230 computes the data directory from the content segment data structure in the metadata entry associated with this read request 745. In an example embodiment, the data directory is computed from a directory hash stored in the metadata entry.

The system then proceeds to open the content segment 750 and read the requested data 755. In an exemplary embodiment, the system can begin to transfer requested data back to the client device as soon as step 755. In other embodiments, the system may wait until all the requested data has been accessed from the one or more content segments before returning anything to the client device.

In an exemplary embodiment, the read method 700 maximizes data throughput by applying a minimum mount time for individual devices. In this embodiment, the read method 700 also avoids read stream starvation by enforcing a maximum mount time for individual devices. The device manager 720 handles balancing minimum and maximum mount times to maximize overall throughput of data.

The read method 700 continues by determining whether any additional content segments need to be processed at 760. If there are no more segments to read, the method 700 returns the data to the file system at 765. In one embodiment, data is returned to the file system (e.g. client device 410) as soon as any portion of a segment is read at 755.

In an exemplary embodiment, after reading the content segment, the file system engine 230 determines whether any additional content segments need to be processed 760 to complete the read request 705. If there are no more segments to read, the file system engine 230 will return the storage device to the device manager 720. The device manager may release the device, taking it out of the working set if necessary to service other I/O requests.

If additional content segments need to be processed 760, then the method 700 loops back to reading the metadata entry at 710. If the next content segment is stored on the same storage device as the previously processed content segment, the storage device can still be in the working set. However, it is possible for the next content segment to be on a different storage device and even at a different storage tier forcing the device manager 720 to prepare and mount a different device 740.

In this embodiment, when all content segments associated with the read request have been processed, the method 700 returns data to the client device via the file system interface 225 at 765. In another embodiment, the method 700 returns data to the client device as soon as the data is read at 755.

Before completing the read process 780, the method 700 determines whether the read request qualifies any of the associated content segments for promotion at 770. Promotion is the process of moving data from lower performing storage tiers to higher performing storage tiers based on a file migration policy. File migration policies generally specify storage tier based on file attributes including last access time, access frequency, creating client device (e.g. file owner), creating client device department, file size and file type. In an example embodiment, the file migration policy may promote a content segment to a higher performing tier if it has been accessed a certain number of times in the past day. If the content segment qualifies for promotion 770, it is added to the promotion list 775. Once a content segment is on the promotion list, migration to a higher performing storage device occurs when the system runs the migration process, detailed below in reference to FIG. 9.

### Data Migration:

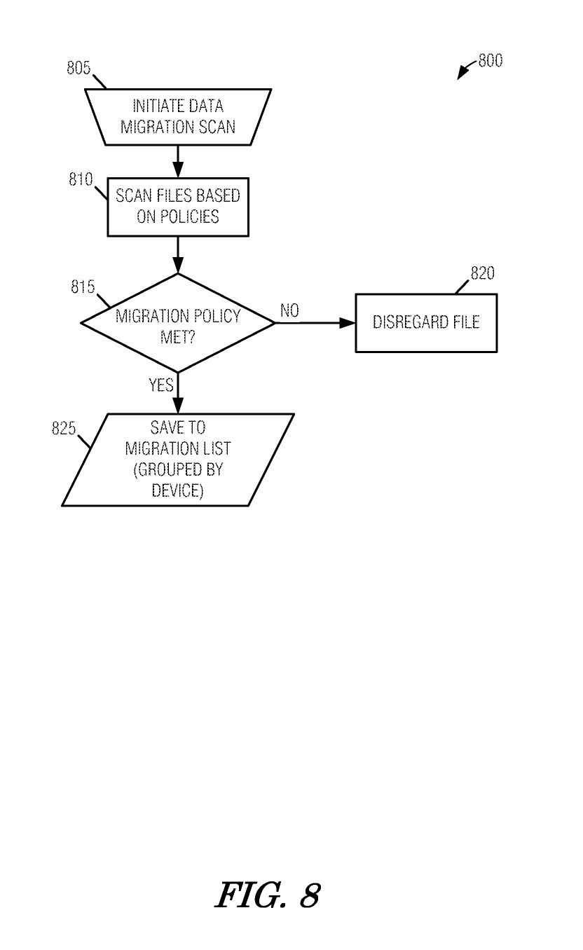

The resource constraint aware network file system architecture provides the opportunity to migrate data between the various storage tiers and devices. Migration can be controlled through the configuration of a file migration policy. In an exemplary embodiment, file migration criteria include access time of the files, file type, file size, and the tier of the storage. In another embodiment, file migration criteria can include file access frequency, file creator/owner information, or any file metadata that might be utilized to characterize a data file. FIGS. 8 and 9 describe the migration process in detail.

FIG. 8 illustrates an exemplary method of scanning the storage system for data migration. The method 800 can be scheduled to occur periodically. In one embodiment, the method 800 can also be manually started by a system administrator via the management interface 260. Initiating the data migration scan 805 causes the method 800 to scan files based on pre-defined file migration policies 810. The file migration policies are completely configurable based on any individual organizations requirements and the nature of the devices connected to the resource constraint aware network file system. For each file the method 800 determines whether the migration policy is met 815. If the policy is not met the file is ignored 820. If the migration policy is met, the file is saved to a migration list 825. In an exemplary embodiment, the migration list is sorted by device in order to ensure efficient migration. The migration list may also be sorted by device group.

FIG. 9 illustrates an exemplary method of migrating data within a resource constraint aware network file system. The data migration method 900 begins by reading 904 the migration list 906. For each file on the migration list 906, the device manager 910 must get the source device 912-916 and destination device 918-922 according to the device ID (device UUID) 912, 918 obtained from the metadata entry associated with the file. FIG. 9 depicts the migration method 900 on a file by file basis, but in another embodiment the process 900 migrates individual content segments (portions of a file). Migration of individual content segments occurs where portions of a file have been accessed more or less frequently making migration to higher or lower storage tiers desirable. As outlined above, the entire migration process 900 is controlled by a system administrator through one or more file migration policies. An example file migration policy includes a requirement to move graphics files (noted by file type or extension) that have not been accessed for three months down one tier.

Prior to accessing a storage device, the device manager 910 determines if the storage group has budget available at 914 and 920. If there is no budget, the system waits for budget to become available at 924 and 926. Once budget becomes available for the target device, the device is prepared and mounted at 916 and 922. In an additional embodiment, budget is allocated at the device level, instead of at the device group level.

Preparing storage devices can include powering on the device, physically moving media into an I/O position, or simply spinning up the disk. Once budget is available within a device group (or on a specific device), the device manager 910 will take the required steps to prepare 916, 922 the targeted device. Mounting the device 916, 922 can involve simply making a logical connection to a storage volume on the device. In this embodiment, both preparation and mounting of the storage devices 916, 922 is handled by the device manager 910.

Once both the source and destination devices are mounted, the method 900 moves the file's content segments to the destination device at 930. Once the content segments are moved to the destination device, the method 900 goes through a series of steps to ensure file integrity 932-944.

File integrity checking begins by calculating a digital signature for the content segment(s) moved at 932. In this embodiment, calculating the digital signature includes reading the moved file at 934. Once the digital signature is calculated the system determines if the new digital signature matches the previous signature at 936. The signatures are based on attributes of the individual content segments that reflect whether the content was altered during migration. If it is determined that the digital signatures do not match the method 900 will roll back 950 the migration of the affected content segment(s) or entire file if necessary.

File integrity checking continues by locking and reading the metadata file at 938. After locking the metadata file, the method 900 checks to make sure the file was not changed before the lock was made effective at 940. If the file did change prior to locking the metadata, the system will once again roll back 950 the migration of the affected content segment(s) or entire file if necessary.

If the file was not changed before the metadata was locked 940, then the method 900 will update the metadata 942 to complete the migration process. In this exemplary embodiment, updating the metadata includes updating the content segment list with new device and directory data regarding the migrated segments. Once updated, the method 900 will commit and unlock the metadata 944 freeing the system to continue any other operations that may be requested on the file.

Before returning devices 960 and completing the migration process, the method 900 checks for additional files for migration 946. If there are additional files in the migration list 906 that have not been migrated, the system loops back to read 904 the next file from the list 906. Reading 904 the file in the list 906 starts the migration process for that file. If there are no more files to be migrated, the method 900 returns the devices 960 to the device manager 910.

### System Provisioning

FIG. 10 illustrates an exemplary system provisioning process for creating device groups and assigning storage devices to the appropriate device group within the resource constraint aware file system. In the exemplary embodiment, devices are added or removed from the system dynamically. Removing a device, does require that all data currently on the system be migrated to a device remaining in the storage pool.

The system provisioning method 1000 starts by creating device groups 1010. Device groups are utilized by the file system to logically connect devices with similar resource constraints. Each device group has a resource budget that is managed by the system to regulate I/O with the devices contained in the group. The budget, also known as resource limit, is used by the device manager to determine if a device can be accessed by the file system. In this exemplary embodiment, the device group contains properties such as group name, storage tier, maximum budget and preferred file system. In this embodiment, maximum budget determines the number of I/O devices within the group that the file system can access at any given moment. The preferred file system allows the user to select the most appropriate file system format to utilize on the underlying storage device. A default file system format will be utilized if the user does not select one.

Once a device group is created 1010, the method 1000 prompts a user to set a group name 1015, set the storage tier 1020, set the resource limit 1025, and set the preferred file system 1030 attributes. The method 1000 allows the user to create and configure additional groups 1035. If no other groups need to be created, then the system moves to assigning storage devices to device groups.

Grouping devices begins by selecting a storage device 1040. Then the method 1000 prompts a user to determine whether the selected device will be put into the metadata device group 1045. The metadata device group is a special group used to group devices for storing the metadata tree and metadata entries. In an exemplary embodiment, one of the primary functions of the metadata is to represent the data structure created by client devices back to the client devices when they connect to the file system. Consequently, it is important that the metadata tree and individual entries always be accessible. In order to facilitate accessibility, the exemplary embodiment requires that the metadata device group only contain disk-based devices. Alternative embodiments base metadata device group membership on resource constraint level or some other storage device performance metric (such as data rate). If the selected device is a metadata device, then the method 1000 checks to ensure that it is a disk-based device at 1050. If the selected device is not a disk-based device, then a user is prompted to select a disk-based device 1055 and the method 1000 loops back to device selection at 1040.

If the selected device is not a metadata device 1045, then the system checks to be sure it is a data storage device 1060. If the selected device is a data storage device, then the user is prompted to put it into the appropriate device group 1065. In an alternative embodiment, the method 1000 can automatically group storage devices based on storage device performance parameters entered by the user or determined automatically by the system (e.g. Device Manager 240). Once the selected device is added to an appropriate group, the method 1000 determines whether any additional devices need to be configured at 1075. Determining whether additional devices need to be configured 1075 is accomplished in an exemplary embodiment by prompting the user. In an alternative embodiment, the method 1000 scans for device connections to devices not already configured. If the selected device is not a data device (determined at 1060), the method 1000 goes directly to determining whether additional devices need to be configured at 1075. The system provisioning method 1000 terminates when there are no additional devices to be configured at 1075.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

The claimed invention is:

1. A data management system comprising:
a plurality of storage devices; and
a server connected to the plurality of storage devices, the server including a file system engine communicatively coupled to the plurality of storage devices;
wherein the file system engine is capable of presenting, to a client device, a uniform file system interface for connecting the client device to the plurality of storage devices;
wherein the file system engine maintains resource constraint information about each of the plurality of storage devices; and
wherein the file system engine accesses a storage policy and distributes portions of a data file, receive over the uniform file system interface, across the plurality of storage devices as a function of the storage policy and the resource constraint information associated with each storage device.

2. The data management system of claim 1, wherein the server further includes a device manager, wherein the device manager connects to the file system engine and the plurality of storage devices; and
wherein the device manager prepares and mounts one or more of the plurality of storage devices when requested by the file system engine.

3. The data management system of claim 1, wherein the file system engine maintains one or more device groups for managing storage devices with similar resource constraints.

4. The data management system of claim 3, wherein each device group maintains a budget for tracking resource availability for the storage devices included in each device group.

5. The data management system of claim 4, wherein the budget is used to determine whether the device group can service a read or write request.

6. The data management system of claim 1, wherein the server further includes a file system interface, wherein the file system interface provides one or more file system methodologies for accessing the plurality of data storage devices as a single unified storage volume.

7. The data management system of claim 6, wherein the plurality of storage devices are formatted according to one or more file system methodologies, wherein at least one of the file system methodologies differs from the file system methodologies provided by the file system interface.

8. A system, comprising:
a first data storage device formatted according to a first file system format;
a second data storage device formatted according to a second file system format, wherein the second file system format is different than the first file system format and wherein the second data storage device is resource constrained;
a server connected to the first and second data storage devices, the server including:
a file system interface;
a file system engine connected to the first and second data storage devices and to the file system interface;
wherein the file system interface provides one or more file system methodologies for accessing the first and second data storage devices as a single unified storage volume;

9. The system of claim 8, wherein the server further includes a device manager, wherein the device manager connects to the file system engine and the first and second data storage devices; and
wherein the device manager prepares and mounts the first and second data storage devices when requested by the file system engine.

10. The system of claim 8, wherein the file system engine maintains one or more device groups for managing storage devices with similar resource constraints.

11. The system of claim 8, wherein each device group maintains a budget for tracking resource availability for the storage devices included in each device group.

12. The system of claim 11, wherein the budget is used to determine whether the device group can service a read or write request.

13. The system of claim 11, wherein the second data storage device is a massive array of idle disks, wherein individual disk drives are powered on in response to an access request.

14. The system of claim 11, wherein the second data storage device is a optical jukebox, wherein individual optical disks are mounted in response to an access request.

15. A method of writing data to a storage system, wherein the storage system provides a file system interface to a plurality of storage devices, wherein the file system interface responds to write requests in one or more file system formats, wherein at least one of the one or more file system formats differs from the file system formats used by the plurality of storage devices, the method comprising:
receiving, at the file system interface, a request to write data onto the storage system;
determining a target storage device and a content segment on the target storage device, wherein determining includes:
determining whether the request is directed toward an existing data file;
if the request is directed to an existing data file:
opening a metadata file associated with the existing data file;
determining whether to write to an existing content segment of the existing data file;
if the request is to write to an existing content segment, obtaining from the metadata file, a target storage device associated with the existing content segment;
if the request is to write to a new content segment:
selecting an available storage device as a target device; and
creating within the metadata file a data entry associated with the content segment;
if the request is directed to a new data file:
creating a new metadata file associated with the new data file;
selecting an available storage device as a target device; and
creating within the new metadata file a data entry associated with a new content segment in the new data file;
connecting to the selected target storage device;
opening the content segment within the selected target storage device;
writing at least a portion of the data to the content segment; and
updating the metadata file associated with the content segment to which the data was written.

16. The method of claim 15, wherein the connecting to the selected target storage device includes a device manager preparing and mounting the target storage device.

17. A method of reading data from a storage system, wherein the storage system provides a file system interface to a plurality of storage devices formatted in a plurality of file system formats, wherein the file system interface responds to read requests in at least one file system format that differs from the plurality of file system formats used by the plurality of storage devices, the method comprising:
receiving at the file system interface a request to read data from the storage system;
reading one or more metadata files associated with the read request;
locating one or more content segments listed in the metadata file;
accessing at least one storage device containing one or more of the content segments;
retrieving the one or more content segments; and
returning the requested data.

18. The method of claim 17, wherein the storage devices each have a resource constraint budget; and
wherein accessing includes determining if the storage device containing one or more of the content segments has available budget.

19. The method of claim 17, wherein the storage devices each belong to a device group that maintains a resource constraint budget; and
wherein accessing includes determining if the device group containing the storage device has available budget.

20. The method of claim 17, wherein accessing includes two or more storage devices containing two or more of the content segments.
